(19) United States
(12) Patent Application Publication
(10) Pub. No.: US 2024/0227408 A1
(43) Pub. Date: Jul. 11, 2024

(54) CONSUMABLE CHIP, CONSUMABLE CARTRIDGE, VERIFICATION METHOD, AND METHOD OF USING CONSUMABLE CHIP

(71) Applicant: Geehy Microelectronics Inc., Zhuhai (CN)

(72) Inventor: Yanqing YUAN, Zhuhai (CN)

(21) Appl. No.: 18/534,344

(22) Filed: Dec. 8, 2023

Related U.S. Application Data
(63) Continuation of application No. PCT/CN2021/141282, filed on Dec. 24, 2021.

(30) Foreign Application Priority Data
Jun. 8, 2021 (CN) 202110637168.3

(51) Int. Cl. B41J 2/175; B41J 29/393

(52) U.S. Cl. CPC B41J 2/17546; B41J 29/393; B41J 2029/3932

(57) ABSTRACT

The present disclosure provides a consumable chip, a consumable cartridge, a verification method, and a method of using the consumable chip. The consumable chip includes a storage module, configured to store verification data, where the verification data at least includes first verification data and second verification data; and a communication module, configured to output the first verification data if an access instruction for verification data is received within a first time interval, and output the second verification data if the access instruction for verification data is received within a second time interval.

### CROSS-REFERENCE TO RELATED APPLICATION

This application is a continuation-in-part application of PCT Patent Application No. PCT/CN2021/141282, filed on Dec. 24, 2021, which claims the priority to Chinese patent application No. 202110637168.3, filed on Jun. 8, 2021, the entirety of all of which is incorporated herein by reference.

### TECHNICAL FIELD

The present disclosure generally relates to the field of image-forming technology and, more particularly, relates to a consumable chip, a consumable cartridge, a verification method, and a method of using the consumable chip.

### BACKGROUND

Currently, printing apparatuses such as laser printing apparatuses and inkjet printing apparatuses have been widely used. Initial information including consumable cartridge model, color, material capacity, manufacturing date and manufacturer code in the printing apparatus, and the image-forming auxiliary information, are recorded on a consumable chip. The consumable chip is attached to the consumable cartridge (e.g., adhered or clamped to the consumable cartridge). The consumable chip is configured to control verification and data matching between the consumable cartridge and the printing apparatus. In order to verify the consumable chip, a unique set of verification data is stored on the consumable chip. When the consumable chip is installed in the printing apparatus, the printing apparatus reads the verification data and performs corresponding verification processing. The printing apparatus verifies the consumable cartridge based on the verification data stored in the consumable chip. Only the consumable cartridge is allowed to be used after passing the verification.

In the existing technology, in order to prevent the only set of verification data stored on the consumable chip from not being recognized by the printing apparatus, the consumable chip includes multiple sets of switchable verification data. When it is found that the printing apparatus cannot recognize the consumable chips, these consumable chips may switch to another set of verification data, such that switched verification data may be recognized by the printing apparatus, and the consumable chips may be used on the printing apparatus. When performing verification, if currently used verification data is successfully verified, the printing apparatus may send fixed-format feedback data to the consumable chip. If verification fails, feedback data in a format different from above-mentioned fixed format may be sent. As a result, the consumable chip may determine whether it is necessary to switch to new verification data for re-verification based on differences in communication format and content of the feedback data.

However, the printing apparatus may interfere the operation of the consumable chip by upgrading the format of its communication instructions. Regardless of whether currently used verification data is successfully verified, there is no difference in the communication format, content and the like of the feedback data. In such scenario, the consumable chip cannot determine whether the printing apparatus recognizes the consumable chip, so that the consumable chip may not be able to switch to new verification data, resulting in verification failure and unusable consumable cartridge. Furthermore, the printing apparatus may also actively trigger the consumable chip to frequently switch verification data through firmware update, and blacklist multiple sets of verification data of the consumable chip in advance, such that the consumable chip may not be used.

### SUMMARY

One aspect of the present disclosure provides a consumable chip. The consumable chip includes a storage module, configured to store verification data, where the verification data at least includes first verification data and second verification data; and a communication module, configured to output the first verification data if an access instruction for verification data is received within a first time interval, and output the second verification data if the access instruction for verification data is received within a second time interval.

Another aspect of the present disclosure provides a consumable chip cartridge including a consumable chip. The consumable chip includes a storage module, configured to store verification data, where the verification data at least includes first verification data and second verification data; and a communication module, configured to output the first verification data if an access instruction for verification data is received within a first time interval, and output the second verification data if the access instruction for verification data is received within a second time interval.

Another aspect of the present disclosure provides a verification method of a consumable chip, where the consumable chip stores verification data at least including first verification data and second verification data. The method includes if an access instruction for the verification data is received within the first time interval, outputting the first verification data; and if the access instruction for the verification data is received within the second time interval, outputting the second verification data.

Another aspect of the present disclosure provides a method of using the consumable chip, applied to the consumable chip. The method includes an installation process, configured to install the consumable chip in a printing apparatus; a determination process, configured to determine whether the consumable chip is recognized by the printing apparatus; a removing process, configured to remove the consumable chip from the printing apparatus if the consumable chip is not recognized by the printing apparatus; and a placing process, configured to place the consumable chip for a preset waiting time.

Another aspect of the present disclosure provides a consumable chip. The consumable chip stores verification data at least including first verification data and second verification data, where the first verification data is different from the second verification data. The consumable chip is configured to only output the first verification data when an access instruction for verification data is received before a first preset time; and configured to only output the second verification data when the access instruction for verification data is received after the first preset time, where the first preset time is determined by the consumable chip itself.

Other aspects of the present disclosure may be understood by those skilled in the art in light of the description, the claims, and the drawings of the present disclosure.

### BRIEF DESCRIPTION OF THE DRAWINGS

To clearly describe technical solutions of various embodiments of the present disclosure, the drawings which need to be used for describing various embodiments are described below. Obviously, the drawings in the following description are merely some embodiments of the present disclosure. For those skilled in the art, other drawings may be obtained in accordance with the drawings without creative efforts.

FIG. 1 illustrates a structural schematic of a printing apparatus provided by exemplary embodiments of the present disclosure.

FIG. 2 illustrates a structural block diagram of a consumable chip provided by exemplary embodiments of the present disclosure.

FIG. 3 illustrates another structural block diagram of a consumable chip provided by exemplary embodiments of the present disclosure.

FIG. 4 illustrates a schematic of a verification data switching scenario provided by exemplary embodiments of the present disclosure.

FIG. 5 illustrates another structural block diagram of a consumable chip provided by exemplary embodiments of the present disclosure.

FIG. 6 illustrates a flowchart of a verification method of a consumable chip provided by exemplary embodiments of the present disclosure.

FIG. 7 illustrates another flowchart of a verification method of a consumable chip provided by exemplary embodiments of the present disclosure.

FIG. 8 illustrates a flowchart of a method of using a consumable chip provided by exemplary embodiments of the present disclosure.

FIG. 9 illustrates another structural schematic of a consumable chip provided by exemplary embodiments of the present disclosure.

FIG. 10 illustrates a flowchart of a verification data switching method provided by exemplary embodiments of the present disclosure.

FIG. 11 illustrates another flowchart of a verification data switching method provided by exemplary embodiments of the present disclosure.

FIG. 12 illustrates another flowchart of a verification data switching method provided by exemplary embodiments of the present disclosure.

FIG. 13 illustrates another flowchart of a verification data switching method provided by exemplary embodiments of the present disclosure.

FIG. 14 illustrates another flowchart of a verification data switching method provided by exemplary embodiments of the present disclosure.

FIG. 15 illustrates a structural schematic of an electronic device provided by exemplary embodiments of the present disclosure.

### DETAILED DESCRIPTION

In order to better understand the technical solutions of the present disclosure, embodiments of the present disclosure are described in detail below with reference to accompanying drawings.

It should be understood that described embodiments are only some of embodiments of the present disclosure, rather than all of embodiments. According to embodiments in present disclosure, all other embodiments obtained by those skilled in the art without making creative efforts should fall within the protection scope of present disclosure.

The terms used in embodiments of the present disclosure are only for the purpose of describing specific embodiments and not intended to limit the present disclosure. As used in embodiments and appended claims, the singular forms “a,” “the” and “said” are also intended to include plural forms, unless the context clearly dictates otherwise.

It should be understood that the term “and/or” used in the present disclosure is only an association relationship describing related objects, indicating that there may be three relationships. For example, A and/or B may indicate three cases: A alone, both A and B, and B alone. In addition, the character “/” in the present disclosure indicate that related objects are an “or” relationship.

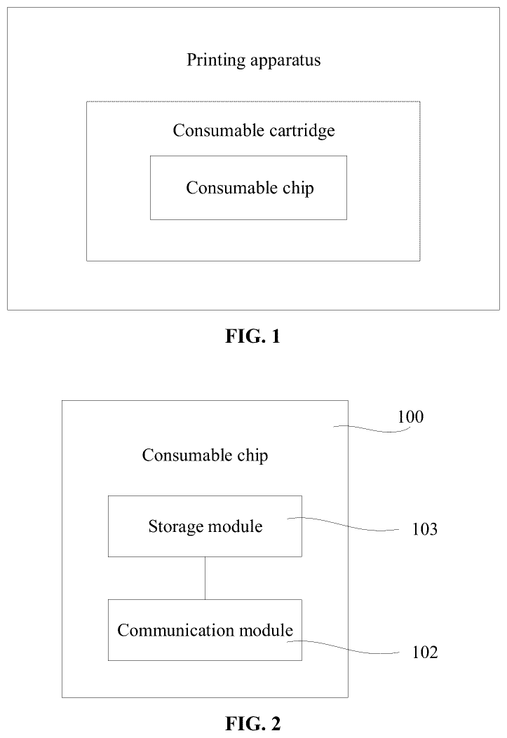

Referring to FIG. 1, FIG. 1 illustrates a structural schematic of a printing apparatus provided by exemplary embodiments of the present disclosure. As shown in FIG. 1, the printing apparatus may include a consumable cartridge which may be disposed with a consumable chip. Printing apparatuses may include laser printers, inkjet printers, dot matrix printers, and thermal printers. The consumable cartridge may be detachably installed on the printing apparatus. The consumable cartridge be an ink cartridge that contains ink, a toner cartridge that contains toner, or a toner cartridge that contains toner, a toner bin, a ribbon cartridge, a label tape cartridge and the like. The consumable chip may also be detachably installed on the consumable cartridge. For example, the consumable chip may be attached to the consumable cartridge (e.g., adhered or clamped to the consumable cartridge). The consumable chip may mainly play the role of identification and providing record of material usage. For example, initial information of the consumable cartridge such as model, color, recording material capacity, manufacturing date and manufacturer code may be recorded in the consumable chip. The consumable chip may control the verification and data matching between the consumable cartridge and the printing apparatus. The consumable chip and the printing apparatus may exchange information through a communication circuit in the consumable chip.

In an optional implementation manner, in order to perform identity verification on the consumable chip, verification data may be stored in the consumable chip. After the consumable chip is installed in the printing apparatus, the printing apparatus may read the verification data and perform corresponding verification processing, thereby preventing unverified products from being applied to the printing apparatus. In some optional implementation manners, the verification data may be a serial number assigned by the manufacturer to each original consumable chip. The serial number is unique to each consumable chip, that is, the serial number of each consumable chip is different. Certain printing apparatus may also record the verification data of the consumable chip into the memory of the printing apparatus, thereby restricting the use of consumable chips with same verification data (that is, used verification data may be added to the blacklist). Based on such scenario, various consumable chips may switch verification data (such as serial numbers). Such type of consumable chips may store multiple sets of verification data. When the printing apparatus cannot recognize the consumable chip, these consumable chips may switch own verification data to another data set. Therefore, verification data after switching may be recognized by the printing apparatus, and the consumable chip may be used on the printing apparatus.

However, existing consumable chips may determine whether the printing apparatus recognizes the consumable chip by identifying differences in external signal characteristics such as the communication instruction format of the printing apparatus. The printing apparatus may interfere the operation of the consumable chip by upgrading the communication instruction format of the printing apparatus. In such scenario, the consumable chip cannot determine whether the printing apparatus recognizes the consumable chip. Furthermore, the printing apparatus may also actively trigger the consumable chip to frequently switch verification data through firmware update, and blacklist multiple sets of verification data of the consumable chip in advance, such that the consumable chip may not be used.

In order to solve above problems, embodiments of the present disclosure provide a consumable chip, which may not be cracked or interfered by external signal, may have strong upgrade resistance and prevent the interference of external signal from causing the switching manner of the consumable chip to fail or prevent the verification data of the consumable chip from being read in advance by the printing apparatus and added to the blacklist. The consumable chip is described in detail with reference to accompanying drawings hereinafter.

Referring to FIG. 2, FIG. 2 illustrates a structural block diagram of a consumable chip provided by exemplary embodiments of the present disclosure. As shown in FIG. 2, the consumable chip may mainly include following exemplary modules.

The consumable chip may include a storage module 103 which may be configured to store verification data. The verification data may at least include first verification data and second verification data.

In embodiments of the present disclosure, the storage module 103 may store information of the consumable chip 100. For example, the information of the consumable chip 100 may include read-write or read-only information such as the manufacturing date and the manufacturer of the consumable chip 100, the color of a recording material (such as ink or toner), the capacity of the recording material, remaining amount or consumed amount of the recording material, the number of printable pages, the number of printed pages and the like.

In embodiments of the present disclosure, the storage module 103 may also store multiple sets of verification data, such as the first verification data and the second verification data different from the first verification data. “First” and “second” in embodiments of the present disclosure may be only configured to distinguish two objects of a same type, such as verification data, and may not specifically refer to the difference in order, advantage, and size between two objects. If the first verification data is outputted by default, the second verification data and other verification data may be regarded as backup verification data. The verification data may include one or more of a chip serial number, a toner serial number, an ink serial number, a digital signature, seed data or verification data, and may also include data associated with the consumable chip. For example, if the serial number is associated with the manufacturing date, the verification data may include not only the serial number, but also include the manufacturing date information associated with the consumable chip.

The storage module 103 may use common non-volatile memories, such as erasable programmable read-only memory (EPROM), electrically erasable programmable read-only memory (EEPROM), FLASH, ferroelectric memory, phase change memory and the like, and may also use a solution of volatile memory plus power supply, such as static random access memory (SRAM)+battery or capacitor, dynamic random access memory (DRAM)+battery or capacitor.

The consumable chip may include a communication module 102, configured to output the first verification data if an access instruction for verification data is received within the first time interval, and configured to output the second verification data if the access instruction for verification data is received within the second time interval.

For example, the communication module 102 may be configured for input and output communication with external device. When the consumable chip 100 is installed in the printing apparatus, the communication module 102 may be configured to receive information sent by the printing apparatus and send information to the printing apparatus. The communication module 102 may include a contact and/or coil (antenna). The communication between the communication module 102 and the printing apparatus may be a wired connection manner, that is, a contact manner, such as communication through the contact of the communication module 102 and the contact on the printing apparatus. The communication between the communication module 102 and the printing apparatus may also be a wireless connection manner, that is, a non-contact manner, such as communication through the coil (antenna) on the printing apparatus and the coil (antenna) of the communication module 102.

In embodiments of the present disclosure, a mapping relationship between verification data and time may be established, and the communication module 102 may output corresponding verification data according to the mapping relationship. For example, if the access instruction for verification data is received within the first time interval, only the first verification data may be outputted; and if the access instruction for verification data is received within the second time interval, only the second verification data may be outputted. The first time interval and the second time interval may be two continuous time periods. For example, the first time interval may be 0-360 h; and the second time interval may be 361-720 h. Or the first time interval and the second time interval may be two discontinuous time periods. For example, the first time interval may be 0-360 h; and the second time interval may be 481-720 h. Specific configuration of the first time interval and the second time interval may not be limited in embodiments of the present disclosure.

It may be understood that in above-mentioned solution, the consumable chip 100 may switch the verification data such as the serial number when a condition (preset time) is satisfied without external interference. On the one hand, backup verification data stored in the consumable chip 100 may be prevented from being read in advance and blacklisted by the printing apparatus; and on the other hand, even if the printing apparatus changes the format and content of the communication instruction, switching the verification data by the consumable chip 100 may not be affected. The condition for the consumable chip 100 to switch the verification data may be controlled by the consumable chip 100 itself and may not be affected by the instruction and upgrade of the printer; and the consumable chip 100 may switch the verification data when the preset time is reached, thereby effectively dealing with the blacklist of the printing apparatus. Furthermore, the backup verification data may be stored in the consumable chip 100 in a relatively secret manner and may be not easily obtained by competitors through trials and testing manners in advance, thereby effectively preventing the verification data from being leaked in advance.

In order to control the switching time of the verification data in the consumable chip 100, in some optional implementation manners, the consumable chip 100 may also be configured with a control module and a timing module.

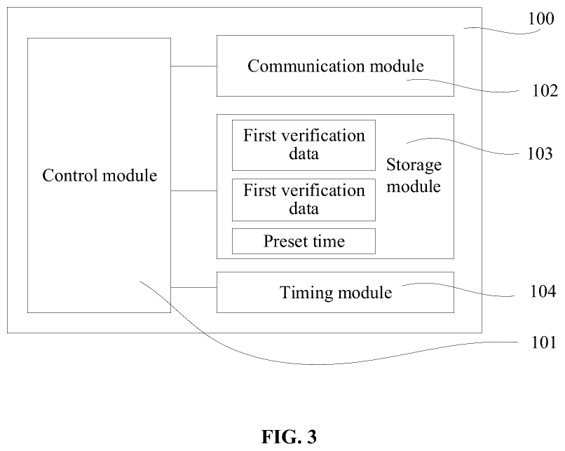

Referring to FIG. 3, FIG. 3 illustrates another structural block diagram of a consumable chip provided by exemplary embodiments of the present disclosure. As shown in FIG. 3, in addition to the storage module 103 and the communication module 102, the consumable chip 100 may also include a control module 101 and a timing module 104, where the communication module 102, the storage module 103 and the timing module 104 may be all electrically connected to the control module 101. The working principles of the storage module 103 and the communication module 102 refer to the description of above-mentioned embodiments shown in FIG. 2. The control module 101 and the timing module 104 are described in detail hereinafter.

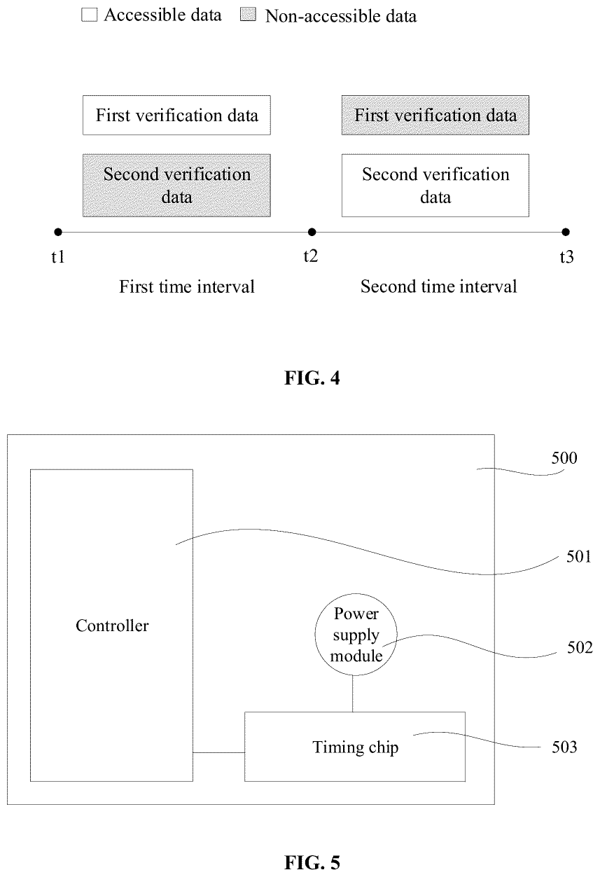

The control module 101 may be configured to set the first verification data as the first set of accessible verification data at the starting time point of the first time interval; and set the second verification data as the second set of accessible verification data at the starting time point of the second time interval, where only one set of accessible verification data may be available at a same time point. For example, in FIG. 4, the first time interval may be t1˜t2, and the second time interval may be t2˜t3. In embodiments of the present disclosure, the first verification data may be set as the first set of accessible verification data at time point t1, and accessible verification data may be switched to the second verification data at time point t2. That is, in the time interval t1 to t2, only the first verification data may be accessible verification data. Therefore, when the access instruction for verification data is received within the time interval t1 to t2, only the first verification data may be outputted. In the time interval t2˜t3, only the second verification data may be accessible verification data.

In order to control the switching time-point of the verification data, the timing module 104 may also be configured in embodiments of the present disclosure. For example, the timing module 104 may start timing at the starting time point of the first time interval; and if the timing length of the timing module 104 reaches the length of the first time interval, the second verification data may be set as the first set of accessible verification data. For example, in the implementation manner shown in FIG. 4, at time point t1, the timing module 104 may start timing; and when the timing length reaches t2−t1 (that is, the time point t2 is reached), the second verification data may be set as the second set of accessible verification data. The time length of the first time interval may be a preset time stored in the storage module 103, such as 720 hours.

In an implementation, the control module 101 may be a microcontroller (MCU), a microcontroller, a field programmable gate array (FPGA), a logic circuit (application specific integrated circuit ASIC) or the like, configured to control the communication between the consumable chip 100 and the printing apparatus, read information from the storage module 103 and store information to the storage module 103.

The timing module 104 may be a module used for timing/counting. When the counting interval is constant, timing may be implemented by counting. The timing module 104 may be a real time clock (RTC) module. RTCs using crystal oscillators (external oscillators) may be independently designed timing chips, such as RTC-4553, SD2000, DS1388 and other models, where the crystal oscillator frequency may be 32.768 kHz. Therefore, when the RTC counting value reaches 32768, it indicates that the timing value is 1 second. In an integrated circuit, the timing module 104 may use an internal oscillator, such as an RC oscillator, a programmable oscillator or the like.

Moreover, the timing module 104 may have different configuration modes and output modes. In one embodiment, the timing module 104 may directly output the counting value externally. Therefore, the consumable chip 100 may determine whether the timing value reaches or exceeds the preset time through determining the counting value of the timing module 104. In such case, the storage module 103 of the consumable chip 100 may need to store preset time information used for comparison with the timing module 104, as shown in the storage module 103 in FIG. 3.

In other embodiments, a counting threshold may be configured and stored in the timing module 104. When the timing reaches the counting threshold, the register of the timing module 104 may output different timing states. For example, when the timing does not reach the counting threshold, the timing state may be the first state, such as 0, 00 or the like; and when the timing reaches the counting threshold, the timing state may be the second state, such as 1 or FF. When the consumable chip 100 determines that the timing state of the timing module 104 is in the second state, it may determine that the timing value or counting value of the timing module 104 may reach or exceed the preset time. In such case, the storage module 103 may not need to store the preset time information.

The consumable chip 100 may also include a circuit board for carrying the control module 101, the communication module 102, the storage module 103 and the timing module 104 mentioned above. In one embodiment, the control module 101, the communication module 102, the storage module 103 and the timing module 104 may be integrated in a same circuit. The circuit may be designed as an integrated circuit (ASIC) and embodied in the form of a wafer, such that the consumable chip 100 may include the wafer and the circuit board carrying the wafer.

When the consumable chip 100 is installed in the printing apparatus, the printing apparatus may provide power to the consumable chip 100 to cause the consumable chip 100 to operate. Therefore, the timing module 104 of the consumable chip 100 may start timing when receiving the power supply from the printer. In order to enable the timing module 104 of the consumable chip 100 to perform timing without external power supply, the consumable chip 100 may also include a power supply module for supplying power to the timing module 104. The power supply module may be a button battery, a capacitor or a lithium battery with relatively small volume. The power supply module may be configured on the consumable chip 100, for example, may also be carried on the circuit board. In other embodiments, the power supply module may be connected to the consumable chip 100 through wires without being configured on the consumable chip 100.

In order to achieve the objectives of the present disclosure, the consumable chip 100 may operate cooperatively as the following. The communication module 102 of the consumable chip 100 may output the first verification data of the storage module 103 by default. Therefore, in such initial situation, what the printing apparatus may read from the consumable chip 100 is the first verification data. The timing module 104 may start timing when shipping from the factory or being sold. It is assumed that when the consumable chips 100, is manufactured, the preset time may be 720 hours. Therefore, when the consumable chip 100 is accessed by the printing apparatus within 720 hours after shipping from the factory (an example of the first time interval), the second verification data may not be outputted externally and may maintain the output of the first verification data. In addition, when the timing module 104 counts to the preset time (720 hours which is an example of the second time interval; and if the timing module 104 outputs a counting value, 720 hours is converted into a counting value of 32768×720×3600=84934656000), if the consumable chip 100 has external power supply at this time point, the control module 101 may compare the timing value obtained from the timing module 104 with the preset time (the information of the preset time may be stored in the storage module 103). If the timing value is determined to equal to the preset time, the second verification data in the storage module 103 may be set as valid and accessible verification data to replace the first verification data, thereby realizing switching of the verification data. When receiving an access request from the external device or the printing apparatus, the communication module 102 may output the second verification data externally.

In one embodiment, the timing module 104 may not output the timing value but output the timing state externally. Therefore, when the consumable chip 100 is manufactured, the counting threshold of the timing module 104 may be configured. For example, the counting threshold corresponding to the preset time of 720 hours may be 84934656000. When the counting of the timing module 104 does not reach such threshold, the timing state outputted by the timing module 104 may be the first state. When the control module 101 of the consumable chip 100 obtains the first state, the operation of switching the verification data may not be performed. If the control module 101 obtains the second state from the timing module 104, it indicates that the counting of the timing module 104 has reached the counting threshold (that also is, it indicates that the timing has reached or exceeded the preset time). Therefore, the control module 101 may switch accessible verification data in the storage module 103, for example, switch from the first verification data to the second verification data.

In one embodiment, the consumable chip 100 is still circulating in the logistics channel more than 720 hours after shipping from the factory but is not installed on the printing apparatus by the user, the consumable chip 100 may not switch stored verification data since the consumable chip 100 has no external power supply. As long as the user installs the consumable chip 100 in the printing apparatus and supplies power to the consumable chip 100 through the printing apparatus, the consumable chip 100 may obtain and determine the timing value or timing state of the timing module 104 at a power-on initialization stage. After determining that the timing exceeds the preset time, the consumable chip 100 may perform switching operation on the verification data, which may ensure that the verification data accessed by the printing apparatus has been switched to backup verification data (such as the second verification data) instead of default verification data configured at the factory.

FIG. 9 illustrates another structural schematic of a consumable chip provided by exemplary embodiments of the present disclosure. As shown in FIG. 9, the consumable chip 100 provided by embodiments of the present disclosure may include the control module 101, a battery module 107 and a battery monitoring module 108. The battery module 107 may provide power to the battery monitoring module 108 when the consumable chip 100 is not powered by an external device, such as the printing apparatus. The battery module 107 may be a button battery, a capacitor, a lithium battery or the like with relatively small volume. In other embodiments, the battery module 107 may also be connected to the consumable chip 100 through wires without being configured on the consumable chip 100.

The battery monitoring module 108 may be configured to monitor the battery power of the battery module 107 to obtain battery power data of the battery module 107. In some embodiments, the battery monitoring module 108 may be a coulomb counter and use advanced fuel measurement algorithms to accurately measure remaining battery power of the battery module 107. In other embodiments, the battery monitoring module 108 that implements battery power monitoring may be integrated into the control module. At this point, the battery monitoring module 108 may not need to be independently disposed in the consumable chip 100.

The control module 101 may be configured to switch the verification data according to the battery power data of the battery module 107. In an implementation manner, the control module 101 may obtain the battery power data monitored by the battery monitoring module 108 and control the verification data switching process according to the battery power data. A storage circuit may be included in the control module 101. The storage circuit may store at least two different sets of verification data, such as the first verification data and the second verification data. Above-mentioned verification data switching may be switching from externally outputting the first verification data currently selected to outputting the second verification data or may be switching from externally outputting the second verification data currently selected to outputting the first verification data.

Above-mentioned consumable chip 100 may also include a circuit board (not shown in FIG. 9). The circuit board may carry the control module 101, the battery module 107 and the battery monitoring module 108 mentioned above. In an optional implementation manner, the control module 101 and the battery monitoring module 108 may be integrated into a same circuit. Such circuit may be designed as an integrated circuit and embodied in a wafer. In an implementation manner, the consumable chip 100 may include the wafer and the circuit board carrying the wafer.

Referring to FIG. 5, FIG. 5 illustrates another structural block diagram of a consumable chip provided by exemplary embodiments of the present disclosure. The consumable chip 500 may be implemented using existing controller 501. The consumable chip 500 may include a controller 501, a timing chip 503 and a power supply module 502 (e.g., a power supply battery). The power supply module 502 may provide power to the timing chip 503 when the consumable chip 500 has no external power supply. The timing chip 503 may be one of above-mentioned timing modules. The controller 501 may be, for example, a microcontroller (MCU), a microcontroller, an FPGA, a logic circuit (ASIC) or the like, which may integrate various functions of the control module, the storage module and the communication module in FIG. 3. The controller 501 may obtain the timing value/counting value of the timing chip 503 when there is an external power supply. Therefore, when the timing value reaches or exceeds the preset time, the verification data outputted externally may be controlled to switch from the first verification data to the second verification data.

Corresponding to above-mentioned consumable chip, embodiments of the present disclosure further provide a verification method of the consumable chip.

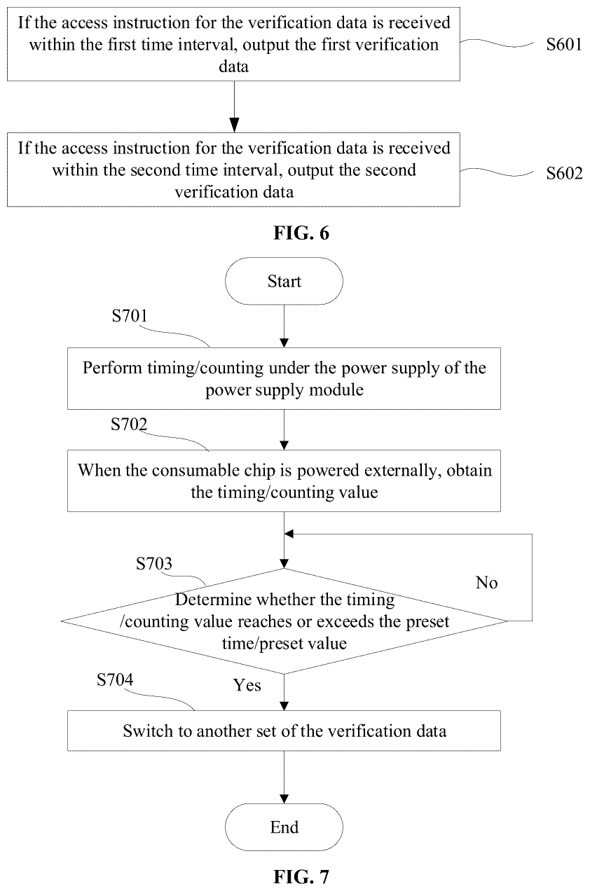

Referring to FIG. 6, FIG. 6 illustrates a flowchart of a verification method of the consumable chip provided by exemplary embodiments of the present disclosure. Such verification method may be applied to the consumable chip shown in above-mentioned embodiments. As shown in FIG. 6, the verification method may mainly include following exemplary steps.

At S601, if the access instruction for the verification data is received within the first time interval, the first verification data may be outputted.

At S602, if the access instruction for the verification data is received within the second time interval, the second verification data may be outputted.

In embodiments of the present disclosure, the mapping relationship between the verification data and time may be established, and the communication module may output corresponding verification data according to the mapping relationship. For example, if the access instruction for the verification data is received within the first time interval, the first verification data may be outputted; and if the access instruction for the verification data is received within the second time interval, the second verification data may be outputted.

Using the control method, the consumable chip may switch the verification data such as the serial number when a condition (preset time) is satisfied without external interference. On the one hand, backup verification data stored in the consumable chip may be prevented from being read in advance and blacklisted by the printing apparatus; and on the other hand, even if the printing apparatus changes the format and content of the communication instruction, switching the verification data by the consumable chip may not be affected. The condition for the consumable chip to switch the verification data may be controlled by the consumable chip itself and may not be affected by the instruction and upgrade of the printer; and the consumable chip may switch the verification data when the preset time is reached, thereby effectively dealing with the blacklist of the printing apparatus. Furthermore, the backup verification data may be stored in the consumable chip in a relatively secret manner and may be not easily obtained by competitors through trials and testing manners in advance, thereby effectively preventing the verification data from being leaked in advance.

In an implementation manner, in order to control the switching time of the verification data, the consumable chip may be also configured with the timing module. The verification method of the consumable chip is described from the perspective of internal implementation of the consumable chip.

Referring to FIG. 7, FIG. 7 illustrates another flowchart of a verification method of a consumable chip provided by exemplary embodiments of the present disclosure. Such verification method may be applied to the consumable chip shown in above-mentioned embodiments. As shown in FIG. 7, the verification method may mainly include following exemplary steps.

At S701, the timing module of the consumable chip may perform timing/counting under the power supply of the power supply module.

In order to enable the timing module of the consumable chip to perform timing without external power supply, the consumable chip may be configured with a power supply module; or a power supply module may be connected to the timing module of the consumable chip, and the power supply module may provide operating power to the timing module. The power supply module may be a button battery, a capacitor or a lithium battery with relatively small volume. Therefore, at S701, the timing module of the consumable chip may be powered by the power supply module (battery) and perform timing or counting without being affected by external power supply. In one embodiment, during the manufacturing process of the consumable chip, the battery may be installed on the consumable chip. The power from the power supply module such as a battery may be provided to the timing module, and the timing module may start timing or counting at this time.

At S702, when the consumable chip is powered externally, the timing/counting value may be obtained.

In one embodiment, the consumable chip may output the first verification data by default. That is, when the external device or the printing apparatus reads the verification data of the consumable chip, the consumable chip may configure the first verification data as valid and accessible verification data. When the consumable chip is purchased by the user and installed on the printing apparatus, the printing apparatus may provide power to the consumable chip. When the consumable chip has external power supply, the chip may be powered on and initialized. Under the control of a program or logic circuit, at this time, the counting value or timing value of the timing module may be obtained.

At S703, whether the timing/counting value reaches or exceeds the preset time/preset value may be determined.

For example, it is determined whether the timing value or counting value of the timing module reaches or exceeds the preset time. Depending on the configuration manner and output manner of the timing module, the manner of the consumable chip determining whether the preset time is reached or exceeded may be also different.

In one embodiment, the timing module may directly output the counting value externally. Therefore, the consumable chip may determine whether the timing value reaches or exceeds the preset time through determining the counting value of the timing module. In such case, the storage module of the consumable chip may need to store the preset time information for comparison with the timing module, as shown in the storage module in FIG. 3.

In other embodiments, the counting threshold may be configured and stored in the timing module. When the timing reaches the counting threshold, the register of the timing module may output the timing state. For example, when the counting threshold is not reached, the timing state is the first state such as 0, and when the timing reaches the counting threshold, the timing state is the second state such as 1. When the consumable chip determines that the timing state of the timing module is in the second state, it may determine that the timing value or counting value of the timing module reaches or exceeds the preset time. In such case, the storage module may not need to store the preset time information.

Depending on the determination result at S703, when the determination result is that the timing/counting value has not reached or exceeded the preset time/preset value, waiting may be continued, and the timing progress of the timing module may be determined; and when the determination result is that the timing/counting value reaches or exceeds the preset time/preset value, S704 may be executed.

At S704, the consumable chip may switch to another set of the verification data.

When the timing/counting value reaches or exceeds the preset time/preset value, the consumable chip may switch the verification data to another set and output the second verification data externally. That is, when the external device or the printing apparatus reads the verification data of the consumable chip, the consumable chip may configure the second verification data as valid and accessible verification data.

It may be seen that the consumable chip using above method of switching the verification data may switch the verification data such as the serial number when the condition (timing reaches the preset time) is satisfied without external interference. On the one hand, backup verification data stored in the consumable chip may be prevented from being read in advance and blacklisted by the printing apparatus; and on the other hand, even if the printing apparatus changes the format and content of the communication instruction, switching the verification data by the consumable chip may not be affected. The condition for the consumable chip to switch the verification data may be controlled by the consumable chip itself and may not be affected by the instruction and upgrade of the printer; and the consumable chip may switch the verification data when the preset time is reached, thereby effectively dealing with the blacklist of the printing apparatus. Furthermore, the backup verification data may be stored in the consumable chip in a relatively secret manner and may be not easily obtained by competitors through trials and testing manners in advance, thereby effectively preventing the verification data from being leaked in advance.

The objective of the consumable chip storing multiple sets of verification data is to prevent the consumable chip from being recognized by the printing apparatus. Therefore, in other embodiments, when the first verification data outputted by the consumable chip is recognized by the printing apparatus, the consumable chip may stop timing of the timing module (such as clearing the timing module) or stop obtaining the timing value or counting state of the timing module. In such way, there is no need to switch verification data, which may be equivalent to locking the verification data of the consumable chip as the first verification data. The consumable chip may configure mark information (for example, stored in the storage module) in the program or logic control to record that the consumable chip has locked the verification data as the first verification data.

For the scenario where the consumable chip stores more than two sets of verification data, for example, the consumable chip also includes the third verification data, the consumable chip may need to switch the verification data more than once. Therefore, the consumable chip may adopt a flexible manner to switch the verification data multiple times without external interference. For example, the communication module of the consumable chip may output the third verification data when the timing module reaches the preset time again. Following previous example, when the timing module reaches 720 hours, the consumable chip may perform the first verification data switch, clear the timing value of the timing module and re-start the timing; and when the timing module reaches 720 hours again, the control module of the consumable chip may perform the second switch on the verification data of the storage module and configure the third verification data to valid, accessible verification data. Similarly, the consumable chip may switch the verification data every 720 hours. The verification data accessible may be switched among multiple sets of data such as the first verification data, the second verification data, and the third verification data. Therefore, if the consumable chip cannot be recognized by the printing apparatus when the user installs the consumable chip for the first time, the consumable chip may only need to be placed aside for a period of time (no longer than 720 hours), and the consumable chip may be installed in the printing apparatus again. At this point, the consumable chip may output backup verification data (such as the second verification data). If the consumable chip is still not recognized by the printing apparatus, after 720 hours, the user may try to install the consumable chip again, and the consumable chip may output the third verification data.

Fixed re-timing time may not be beneficial for the user to switch current verification data of the consumable chip in a timely manner. Therefore, the second preset time may also be stored in the consumable chip. The second preset time may be shorter than the preset time in above-mentioned embodiments. That is, the time length of the first time interval in one embodiment shown in FIG. 2 may be longer than the length of the second time interval. For example, the second preset time may be 240 hours. After the consumable chip performs the first verification data switch when the timer reaches 720 hours, the consumable chip may also perform the second verification data switch when the second preset time of 240 hours is reached again, such that the third verification data may be outputted externally through the communication module.

Corresponding to above-mentioned embodiments, embodiments of the present disclosure further provide a consumable cartridge. The consumable cartridge may include the consumable chip in above-mentioned embodiments. Specific content of the consumable chip refers to the description of above-mentioned embodiments, which may not be described in detail herein for brevity.

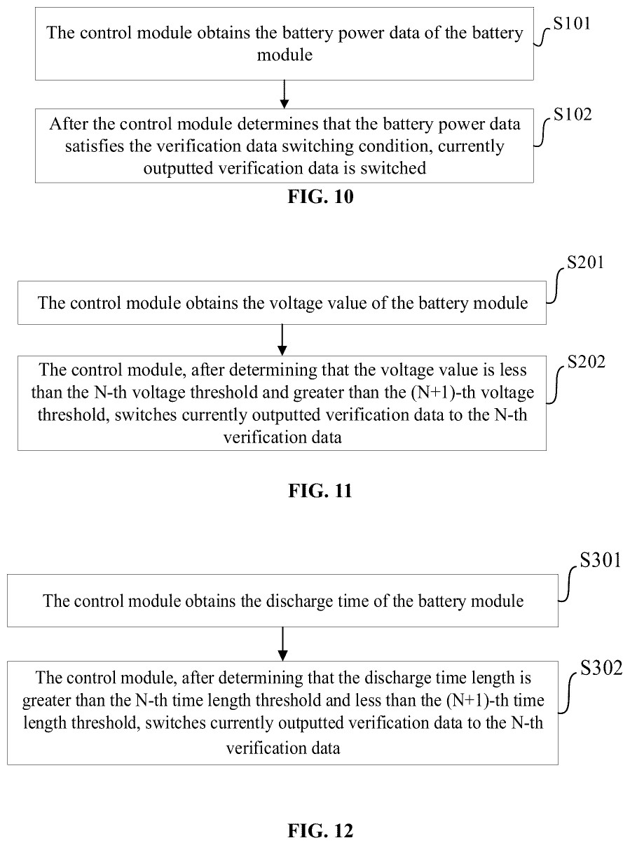

FIG. 10 illustrates a flowchart of a verification data switching method provided by exemplary embodiments of the present disclosure. As shown in FIG. 10, the verification data switching method may include following exemplary steps.

At S101, the control module may obtain the battery power data of the battery module.

At S102, after the control module determines that the battery power data satisfies a verification data switching condition, currently outputted verification data may be switched.

After the consumable chip is manufactured, the battery module configured on the consumable chip may begin to discharge. For example, a fixed current discharge manner may be adopted to discharge at 1 mA current; and may naturally discharge through water vapor, dust or the like in the air. In the case of natural discharge, the discharge current may be less than 1 mA and at the microampere level. At this point, battery modules with relatively small capacity may be configured to save cost.

In an optional implementation manner, the battery monitoring module may start monitoring the battery power data of the battery module after receiving power from the battery module.

In another optional implementation manner, the battery monitoring module may start monitoring the battery power data of the battery module in response to received first monitoring instruction. It should be noted that above-mentioned first monitoring instruction may be automatically triggered after the consumable chip is shipped from the factory or may be automatically triggered after the sale is completed, which may not be limited in the present disclosure.

In embodiments of the present disclosure, the battery power monitoring of the battery module by the battery monitoring module may not be affected by external image-forming apparatus. That is, regardless of whether the consumable cartridge has been installed on the printing apparatus, the battery power data of the battery module may be monitored.

After the consumable cartridge is installed in the printing apparatus, the consumable chip may be in contact with the contact pins of the printing apparatus, such that the printing apparatus may supply power to the consumable chip through the contact pins after being turned on. After the consumable chip is powered on, initialization operation may be automatically performed.

In embodiments of the present disclosure, the trigger condition for the control module to obtain the battery power data of the battery module may be, for example, in response to above-mentioned power-on initialization (that is, the image-forming apparatus supplies power to the consumable chip), or receiving a reset signal sent by the printing apparatus (a level rise curve of a clock or data signal line, a number of clocks or the like), or receiving a preset instruction (such as an instruction to read verification data) or the like, which may not be limited in the present disclosure and may only need to be before the consumable chip sends the verification data or the image-forming apparatus reads the verification data.

For example, when obtaining the battery power data, in an optional implementation manner, the control module may obtain the battery power data from the battery monitoring module. Based on natural discharge or passive discharge of the battery module, the control module may switch currently outputted verification data after the battery power data of the battery module satisfies the verification data switching condition.

For example, multiple sets of verification data may be preset in the consumable chip. The verification data may be, for example, one or more of a chip serial number, a toner serial number, an ink serial number, a digital signature, seed data or verification data; and may also include, for example, data associated with the consumable chip, such as manufacturing date information and the like, which may not be limited in the present disclosure. The consumable chip may specify any set of multiple sets of verification data as the default verification data in the factory configuration, which may be currently outputted verification data.

Furthermore, when multiple sets of verification data are configured in the consumable chip, multiple configured thresholds may also be set. Each configured threshold may be mapped to each verification data. The control module may determine that the battery power data satisfies the verification data switching condition by determining that remaining battery power is lower than the configured threshold. At this point, currently outputted verification data may be switched. For example, when remaining battery power in the battery module is lower than the first configured threshold, the control module may switch currently outputted verification data to the first verification data; when remaining battery power in the battery module is lower than the second configured threshold, the control module may switch currently outputted verification data to the second verification data; and so on, which may not be described in detail. Above-mentioned remaining battery power may also be replaced by any data that may represent the usage of battery power, such as power consumption, which may not be described in detail in the present disclosure.

Through above technical solutions, the consumable chip may realize active switching of verification data and may no longer be restricted and affected by instructions from external devices such as printing apparatuses, thereby improving the reliability of verification data switching and increasing the verification success rate.

In another embodiment of the present disclosure, above verification data switching method is further described.

FIG. 11 illustrates another flowchart of a verification data switching method provided by exemplary embodiments of the present disclosure. As shown in FIG. 11, the verification data switching method may include following exemplary steps.

At S201, the control module may obtain the voltage value of the battery module.

At S202, the control module may, after determining that the voltage value is less than the N-th voltage threshold and greater than the (N+1)-th voltage threshold, switch currently outputted verification data to the N-th verification data.

In the battery-related field, a corresponding relationship may be between the open circuit voltage of the battery and remaining battery power of the battery.

For the convenience of understanding, embodiment of the present disclosure provides a corresponding relationship between the open circuit voltage and remaining battery power of a lithium battery, as shown in Table 1.

TABLE 1

| Battery voltage | Battery power |
|---|---|
| 4.20 V | 100% |
| 4.06 V | 90% |
| 3.98 V | 80% |
| 3.92 V | 70% |
| 3.87 V | 60% |
| 3.82 V | 50% |
| 3.79 V | 40% |
| 3.77 V | 30% |
| 3.74 V | 20% |
| 3.68 V | 10% |
| 3.45 V | 5% |
| 3.20 V | 0% |

It should be noted that Table 1 is only an exemplary description and is not intended to limit embodiments of the present disclosure.

Due to above corresponding relationship, in embodiments of the present disclosure, the battery monitoring module may obtain the battery power data of the battery module by monitoring the voltage value of the battery module.

For example, the battery detection module may monitor the voltage of the battery module according to a set period to obtain the voltage value of the battery module. The value of the set period may be set according to needs, for example, may be 1 hour.

In embodiments of the present disclosure, at least one voltage threshold may be configured in the control module of the consumable chip.

In an optional implementation manner, in addition to the default verification data, the consumable chip may also configure the first verification data and the first voltage threshold. In such implementation manner, the control module may switch currently outputted verification data to the first verification data when determining that obtained voltage value is less than above-mentioned first voltage threshold. Through such implementation manner, the consumable chip may perform one switch on currently outputted verification data.

In an optional implementation manner, in addition to the default verification data, the consumable chip may also configure multiple verification data and multiple voltage thresholds.

In such implementation manner, the control module may switch currently outputted verification data to the first verification data when determining that obtained voltage value is less than the first voltage threshold and greater than the second voltage threshold; and switch currently outputted verification data to the second verification data when determining that obtained voltage value is less than the second voltage threshold and greater than the third voltage threshold; and so on, which may not be described in detail in the present disclosure. Through such implementation manner, the consumable chip may perform multiple switches on currently outputted verification data.

FIG. 12 illustrates another flowchart of a verification data switching method provided by exemplary embodiments of the present disclosure. As shown in FIG. 12, the verification data switching method may include following exemplary steps.

At S301, the control module may obtain the discharge time of the battery module.

At S302, the control module may, after determining that the discharge time length is greater than the N-th time length threshold and less than the (N+1)-th time length threshold, switch currently outputted verification data to the N-th verification data.

In embodiments of the present disclosure, remaining battery power of the battery module is related to the discharge current value and the discharge time length. Therefore, on the basis that the discharge current value of the battery module is stable, the battery monitoring module may monitor the discharge time length of the battery module and obtain the battery power data of the battery module by monitoring the discharge time length.

For ease of understanding, a lithium battery is still used as an example for explanation. Assuming that the capacity of the battery module is 1000 milliamp hours (mAh), discharging is performed through a 4.2 k ohm resistor, and the discharge current is 4.2 V/4.2 k=1 mA. Therefore, the total discharge time of the battery module is 1000 hours. When the battery monitoring module detects that the discharge time reaches 100 hours, remaining battery power may be considered to be (1000−100)/1000=90%.

Based on above description, the battery detection module may compute the discharge time of the battery module. In an exemplary implementation manner, timing may be implemented by a counting manner. The battery monitoring module may be a real time clock (RTC). For example, if a crystal oscillator RTC is used, such as RTC-4553, SD2000, DS1388 and other models, the crystal oscillator frequency may be 32.768 kHz. Therefore, when the RTC counting value reaches 32768, it indicates that the timing value is 1 second. In integrated circuits, battery monitoring modules may use internal oscillators, such as RC oscillators, programmable oscillators and the like.

In embodiments of the present disclosure, the time length of the discharge outputted by the battery monitoring module may be a counting value of the RTC or may be a timing value obtained by mathematical conversion based on the counting value, which may not be limited in the present disclosure.

In embodiments of the present disclosure, at least one time length threshold may be configured in the control module of the consumable chip. It should be noted that if the time length of the charge outputted by the battery monitoring module is a counting value, then the time length threshold herein may be a counting threshold.

In an optional implementation manner, a time length threshold such as the first time length threshold may be configured in the control module. The control module may switch currently outputted verification data to the first verification data when determining that the obtained discharge time length is greater than the first time length threshold. In such implementation manner, the control module may only switch the verification data once.

In another optional implementation manner, multiple time length thresholds may be configured in the control module, such as the first time length threshold, the second time length threshold, and the third time length threshold. The control module may switch the currently outputted verification data to the first verification data when determining that obtained discharge time length is greater than above-mentioned first time length threshold and less than above-mentioned second time length threshold; and may switch the currently outputted verification data to the second verification data when determining that obtained discharge time length is greater than the second time length threshold and less than the third time length threshold; and so on, which may not be described in detail in the present disclosure.

In such implementation manner, the control module may switch currently outputted verification data multiple times.

It should be noted that the time length intervals between above time length thresholds may be same or different. For example, in order to facilitate timely switching of verification data, the time length intervals between all of time length thresholds may be successively decreased.

In another optional implementation manner, a time length threshold such as the first time length threshold may be configured in the control module.

When the control module determines that obtained discharge time length reaches the first time length threshold and switches currently outputted verification data to the first verification data, the battery monitoring module may clear the monitored discharge time length to zero. Next, the battery monitoring module may re-count the discharge time length. When the discharge time length reaches the first time length threshold again, the control module may switch currently outputted verification data to the second verification data; and so on, which may not be limited in the present disclosure. Through such implementation manner, the control module may realize multiple switching of multiple verification data while only storing one time length threshold.

Furthermore, in another embodiment of the present disclosure, the control module may simultaneously obtain the voltage value and the discharge time length of the battery module from the battery monitoring module in response to the verification request of the image-forming apparatus. Moreover, the control module may determine the voltage value and the discharge time length simultaneously.

For example, when the control module determines that the discharge time length is greater than the N-th time length threshold and less than the (N+1)-th time length threshold and when the voltage value is less than the N-th voltage threshold and greater than the (N+1)-th voltage threshold, currently outputted verification data may be switched to the N-th verification data.

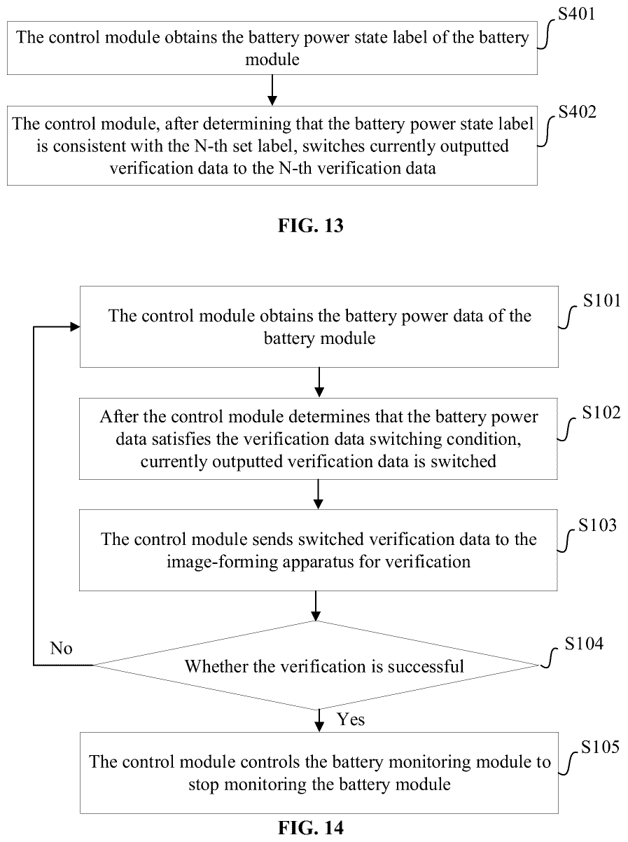

FIG. 13 illustrates another flowchart of a verification data switching method provided by exemplary embodiments of the present disclosure. As shown in FIG. 13, the verification data switching method may include following exemplary steps.

At S401, the control module may obtain the battery power state label of the battery module.

At S402, the control module may, after determining that the battery power state label is consistent with the N-th set label, switch currently outputted verification data to the N-th verification data.

In embodiments of the present disclosure, at least one voltage threshold and/or time length threshold corresponding to the verification data may be stored in the battery monitoring module of the consumable chip.

In the process of monitoring the discharge time length and/or voltage value of the battery module by the battery monitoring module, after determining that the discharge time length is greater than the N-th time length threshold and less than the (N+1)-th time length threshold, and/or the voltage value is less than the N-th voltage threshold and greater than the (N+1)-th voltage threshold, the battery monitoring module may configured the battery state label to be consistent with the N-th set label. The N-th set label may be configured to indicate current remaining battery power, and corresponding specific form may be configured by an agreement between the control module and the battery monitoring module.

After the control module obtains the battery power state label from the battery monitoring module, the control module may compare the battery power state label with each pre-agreed set label. If it is determined that the battery power state label is consistent with the N-th set label, the control module may switch currently outputted verification data to the N-th verification data.

To facilitate understanding, one embodiment is described herein.

It is assumed that the battery power data monitored by the battery monitoring module is the discharge time length, and a first time length threshold is stored in the battery monitoring module, when the battery monitoring module detects that the discharge time length reaches the first time length threshold, current battery power state label may be configured to be consistent with the first set label. For example, the first set label may be 1, FF or the like. On the contrary, if the battery monitoring module detects that the discharge time length does not reach the first time length threshold, current battery power state label may be maintained. For example, current battery power state label may be 0, 00 or the like.

Next, the battery monitoring module may output the battery power state label to the control module. When the control module confirms that the battery power state label is consistent with the first set label (such as 1), currently outputted verification data may be switched to the first verification data.

Based on the implementation manners of embodiments of the present disclosure, there is no need to store the voltage threshold and/or the time length threshold in the control module.

FIG. 14 illustrates another flowchart of a verification data switching method provided by exemplary embodiments of the present disclosure. As shown in FIG. 14, the verification data switching method may include following exemplary steps.

At S103, the control module may send switched verification data to the image-forming apparatus for verification.

At S104, the control module may detect whether the verification is successful. If the verification is successful, execute S105; otherwise, continue to execute S101.

At S105, the control module may control the battery monitoring module to stop monitoring the battery module.

In embodiments of the present disclosure, after the verification data sent by the control module to the image-forming apparatus is successfully verified, the image-forming apparatus may start to perform printing operations. At this point, the control module may control the battery monitoring module to stop monitoring the battery module. For example, the battery monitoring module may no longer monitor the voltage value of the battery module or stop timing the discharge time length (for example, clearing RTC). Meanwhile, the control module may stop obtaining monitored battery power data of the battery monitoring module, stop switching new verification data, and lock the verification data in currently selected state. For example, the control module may configure label information on the program or logic control (for example, store the label information in the storage circuit), and the label information may be configured to record that the verification data has been locked in currently selected state.

Correspondingly, if the verification data sent to the image-formation apparatus fails to be verified, the control module may re-execute S101. When the trigger condition for obtaining the battery power data of the battery module is satisfied again, the battery power data may be re-obtained, and outputted verification data may be switched again based on re-obtained battery power data.

For example, when the user determines that the verification fails based on the display screen of the image-forming apparatus, the user may remove the consumable cartridge from the image-forming apparatus and place the consumable cartridge aside for a preset time length until the battery power data of the battery module in the consumable chip satisfies the verification data switching condition again. Next, the consumable cartridge may be re-installed in the image-forming apparatus to trigger the trigger condition of S101 to obtain the battery power data of the battery module.

Or when the user determines that verification has failed based on the display of the image-forming apparatus, the user may also keep the consumable cartridge in the image-forming apparatus for a preset time length until the battery power data of the battery module in the consumable chip satisfies the verification data switching condition again. Next, the image-forming apparatus may be re-powered on to trigger the trigger condition of S101 to obtain the battery power data of the battery module.

In another embodiment of the present disclosure, the structure and function implementation of the consumable chip are further described in detail.

In embodiments of the present disclosure, as shown in FIG. 9, the consumable chip 100 may include the control module 101 and the battery module 107.

The control module 101 may be configured to obtain the battery power data of the battery module; and after it determines that the battery power data satisfies the verification data switching condition, may be configured to switch currently outputted verification data.

In an implementation manner, the consumable chip 100 may also include the battery monitoring module 108 configured to monitor the battery module 107 to obtain the battery power data. The control module 101 may be configured to obtain the battery power data of the battery module 107 from the battery monitoring module 108.

In an implementation manner, the battery power data may include the discharge time length and/or voltage value. The battery monitoring module 108 may be configured to count the discharge time of the battery module 107 to obtain the discharge time length of the battery module 107; and/or perform voltage detection on the battery module 107 according to a set period to obtain the voltage value of the battery module 107.

In an implementation manner, the control module 101 may be configured to, after determining that the discharge time length is greater than the N-th time length threshold and less than the (N+1)-th time length threshold and/or the voltage value is less than the N-th voltage threshold and greater than the (N+1)-th voltage threshold, switch currently outputted verification data to the N-th verification data, where N is a positive integer.

In an implementation manner, the battery power data may include the battery power state label. The battery monitoring module 108 may be configured to, after determining that the discharge time length is greater than the N-th time length threshold and less than the (N+1)-th time length threshold and/or the voltage value is less than the N-th voltage threshold and greater than the (N+1)-th voltage threshold, set the battery power state label to be consistent with the N-th set label.

In an implementation manner, the control module 101 may be configured to, after determining that the battery power state label is consistent with the N-th set label, switch currently output verification data to the N-th verification data, where N is a positive integer.

Corresponding to above-mentioned embodiments, embodiments of the present disclosure further provide a method of using the consumable chip.

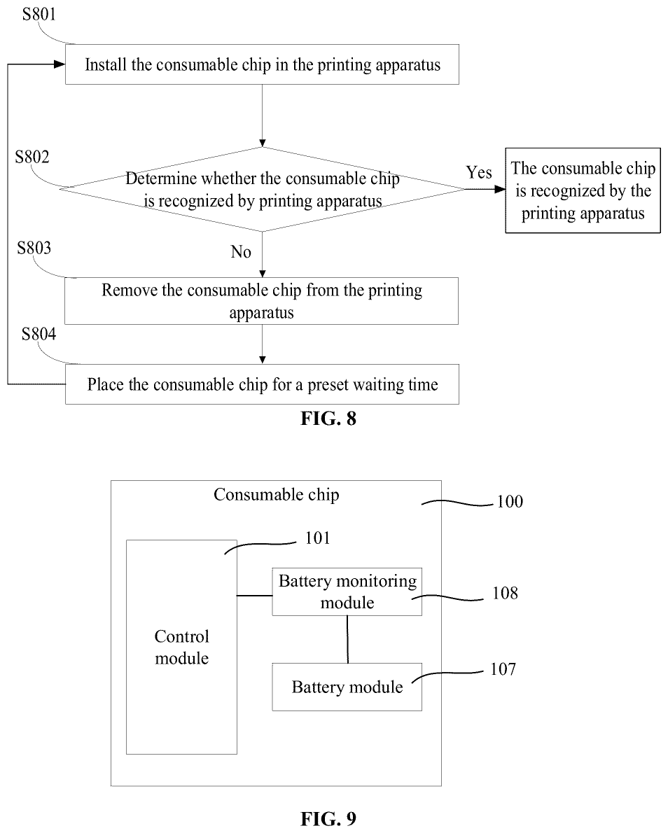

Referring to FIG. 8, FIG. 8 illustrates a flowchart of a method of using the consumable chip provided by exemplary embodiments of the present disclosure. As shown in FIG. 8, the method may mainly include following exemplary steps.

At S801, the consumable chip may be installed in the printing apparatus.

When the user uses the consumable chip, the user may first install the consumable chip containing multiple sets of verification data in the printing apparatus.

At S802, whether the consumable chip is recognized by the printing apparatus may be determined.

The consumable chip may determine whether the consumable chip is recognized by the printing apparatus by receiving the communication instruction sent by the printing apparatus. The consumable chip may determine whether the printing apparatus recognizes the consumable chip by identifying differences in external signal characteristics such as the printing apparatus's communication instruction format, content, and electrical feature during communication. For example, when the verification data of the consumable chip is recognized by the printing apparatus, the printing apparatus may write dynamic correction information to the consumable chip in the first 10 communication instructions. However, when the verification data of the consumable chip is not recognized by the printing apparatus, the printing apparatus may not write dynamic correction information to the consumable chip in the first 10 communication instructions. If the printing apparatus recognizes the consumable chip and the consumable chip matches the printing apparatus, the process ends. If the printing apparatus does not recognize the consumable chip, S803 is executed.

At S803, the consumable chip may be removed from the printing apparatus.

If the consumable chip is not successfully recognized by the printing apparatus after reading the information of the consumable chip, the control circuit of the printing apparatus may output an unrecognized instruction to be displayed on the printing apparatus. After viewing the information, the user may remove the consumable chip from the printing apparatus.

At S804, the consumable chip may be placed for a preset waiting time.

For example, after reaching the preset waiting time, return to S801. Herein, the preset waiting time may be the time to ensure that the verification data may be switched when the consumable chip is re-installed in the printing apparatus. Therefore, the preset waiting time should be greater than or equal to above-mentioned preset time (such as the time length of the first time interval or the second time interval). Since the consumable chip may continue to be used after being placed for a period of time, the waste of the consumable chip may be avoided. Furthermore, there is no need for the consumable chip manufacturer to recall the consumable chip and perform rework processing such as re-burning and upgrading the consumable chip. The rework processing may require removing the packaging and then repacking the consumable chip, which is time-consuming, inefficient, and waste of the packaging material.

It should be noted that although above-mentioned usage method mentions that the user needs to remove the consumable chip from the printing apparatus when placing the consumable chip, which may not be required. The user may not remove the consumable chip and place the consumable chip in the printing apparatus because the consumable chip of the present disclosure determines whether the verification data needs to be switched based on its own counting time which may not be affected by external influence. The consumable chip may be removed out because the user needs to use other spare consumable chips to perform printing.

According to the consumable chip and the method for switching the verification data provided by embodiments of the present disclosure, the timing module may be configured in the consumable chip, and the verification data outputted by the consumable chip may be selectively switched according to the timing state of the timing module. Therefore, when the printing apparatus accesses the consumable chip, the printing apparatus may access different verification data, which may solve the problem that the consumable chip cannot be recognized by the printing apparatus when the verification data is blacklisted.

The consumable chip provided by embodiments of the present disclosure may actively switch the verification data without interference when the condition (e.g., counting to the preset time) is satisfied, which may prevent that the verification data is blacklisted and the consumable chip cannot be used. Compared with the passive switching manner based on instructions sent by the printing apparatus, the consumable chip in embodiments of the present disclosure may be not cracked or interfered by external signals and have strong anti-upgrade capability, which may prevent the interference of external signals from causing the switching manner of the consumable chip to fail, or prevent the verification data of the consumable chip from being read and blacklisted in advance by the printing apparatus or from being obtained by competitors in advance.

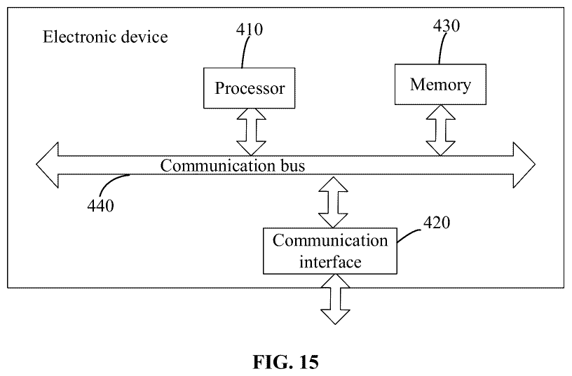

FIG. 15 illustrates a structural schematic of an electronic device provided by exemplary embodiments of the present disclosure. As shown in FIG. 15, above-mentioned electronic device may include at least one processor; and at least one memory communicatively connected with above-mentioned processor. The memory may store program instructions that may be executed by the processor. Above-mentioned processor may execute the verification data switching method provided by embodiments of the present disclosure by calling above-mentioned program instructions. Above-mentioned electronic device may be the consumable chip.

FIG. 15 illustrates a block diagram of an exemplary electronic device suitable for implementing embodiments of the present disclosure. The electronic device shown in FIG. 15 is only an example and should not impose any restrictions on the functions and usage scope of the embodiments of the present disclosure.

As shown in FIG. 15, the electronic device may be embodied as a general computing device. The components of the electronic device may include, but may not be limited to one or more processors 410, a memory 430, and a communication bus 440 connecting different system components (including the memory 430 and the processor 410).

The communications bus 440 may include one or more of certain types of bus structures, including a memory bus or memory controller, a peripheral bus, a graphics accelerated port, a processor, or a local bus using any of a variety of bus structures.

The electronic device may typically include a plurality of computer system readable media. These media may be any available media that may be accessed by the electronic device, including volatile and nonvolatile media, and removable and non-removable media.

The memory 430 may include computer system readable media in the form of volatile memory. The electronic device may further include other removable/non-removable, volatile/non-volatile computer system storage media. Although not shown in FIG. 15, a disk drive for reading and writing a removable non-volatile disk (e.g., a floppy disk), and an optical disk drive for reading and writing a removable non-volatile optical disk may be provided. In these cases, each drive may be connected to the communications bus 440 through one or more data media interfaces. The memory 430 may include at least one program product. The program product may include a set of (e.g., at least one) program modules configured to perform the functions of various embodiments of the present disclosure.

A program/utility having a set (at least one) of program modules may be stored in the memory 430. The program module may perform functions and/or methods in embodiments described in the present disclosure.

The electronic device may also communicate with one or more external devices (e.g., keyboard, pointing device, display and the like). The communication may be performed through the communication interface 420.

The processor 410 may execute various functional applications and verification data switching by running programs stored in the memory 430, for example, may implement the verification data switching method provided by embodiments of the present disclosure.

Embodiments of the present disclosure further provide a consumable chip. The consumable chip stores verification data at least including first verification data and second verification data, where the first verification data is different from the second verification data. The consumable chip is configured to only output the first verification data when an access instruction for verification data is received before the first preset time; and configured to only output the second verification data when the access instruction for verification data is received after the first preset time, where the first preset time is determined by the consumable chip itself. The first preset time is the time point t2, as shown in FIG. 4.

In one embodiment, the first preset time is determined by a timing module of the consumable chip.

In one embodiment, the first preset time is determined by a battery power of a power supply module connected to the consumable chip.

Embodiments of the present disclosure further provide a computer-readable storage medium. The computer-readable storage medium described above may store computer instructions. Above-mentioned computer instructions may cause above-mentioned computer to execute some or all of the steps provided by embodiments of the present disclosure, such as above-mentioned verification data switching method. The storage medium may be a magnetic disk, an optical disk, a read-only memory (ROM) or a random access memory (RAM) or the like.

In an implementation, embodiments of the present disclosure further provide a computer program product. The computer program product may include executable instructions. When executable instructions are executed on the computer, the computer may be caused to perform some or all of the steps in above-mentioned method embodiments.

In embodiments of the present disclosure, “at least one” refers to one or more; and “plurality” refers to two or more. “And/or” describes the relationship between associated objects, indicating that there may be three relationships. For example, A and/or B may represent A alone, both A and B, or B alone. A and B may be singular or plural. The character “/” indicates that related objects are in an “or” relationship. “At least one of the following items” and similar expressions refer to any combination of these items, including any combination of single or plural items. For example, at least one of a, b and c may represent: a, b, c, a-b, a-c, b-c, or a-b-c, where a, b and c are single or multiple.

Those skilled in the art may realize that each unit and algorithm step described in embodiments disclosed herein may be implemented by an electronic hardware, or a combination of computer software and electronic hardware. Whether these functions are performed in hardware or software depends on specific application and design constraints of technical solutions. Those skilled in the art may implement described functionality using different methods for each specific application, but such implementations should not be considered beyond the scope of the present disclosure.

Compared with the existing technology, the technical solutions provided by the present disclosure may achieve at least the following beneficial effects.

In embodiments of the present disclosure, the consumable chip may be not cracked or interfered by external signals and have strong anti-upgrade capability, which may prevent the interference of external signals from causing the switching method of the consumable chip to fail or prevent the verification data of the consumable chip from being read in advance and added to the blacklist by the printing apparatus. The consumable chip may realize active switching of verification data, thereby improving the reliability of verification data switching and improving the verification success rate.

The above may be only optional embodiments of the present disclosure and may not intended to limit the present disclosure. Any changes or substitutions, which are made by those skilled in the art and within the spirit and principle of the present disclosure, shall be included in the protection scope of the present disclosure. The protection scope of the present disclosure shall be subject to the protection scope of the claims.

What is claimed is:

1. A consumable chip, comprising:
a storage module, configured to store verification data, wherein the verification data at least includes first verification data and second verification data; and
a communication module, configured to output the first verification data if an access instruction for verification data is received within a first time interval, and output the second verification data if the access instruction for verification data is received within a second time interval.

2. The consumable chip according to claim 1, further including:
a control module, configured to set the first verification data as a first set of accessible verification data at a starting time point of the first time interval, and set the second verification data as a second set of accessible verification data at a starting time point of the second time interval, wherein only one set of accessible verification data is available at a same time point.

3. The consumable chip according to claim 2, further including:
a timing module, configured to start timing at the starting time point of the first time interval, wherein:
the control module is configured to set the second verification data as the second set of accessible verification data if a timing length of the timing module reaches a time length of the first time interval.

4. The consumable chip according to claim 3, wherein:
a printing apparatus is configured to supply power to the timing module; or
the consumable chip further includes a power supply module configured to supply power to the timing module.

5. The consumable chip according to claim 4, wherein:
the control module is also configured to determine whether the first verification data is recognized by the printing apparatus; and
the timing module is also configured to stop timing if the first verification data is recognized by the printing apparatus.

6. A consumable chip cartridge, comprising:
a consumable chip, comprising:
a storage module, configured to store verification data, wherein the verification data at least includes first verification data and second verification data; and
a communication module, configured to output the first verification data if an access instruction for verification data is received within a first time interval, and output the second verification data if the access instruction for verification data is received within a second time interval.

7. The consumable chip cartridge according to claim 6, wherein:
the consumable chip further includes a control module, configured to set the first verification data as a first set of accessible verification data at a starting time point of the first time interval, and set the second verification data as a second set of accessible verification data at a starting time point of the second time interval, wherein only one set of accessible verification data is available at a same time point.

8. The consumable chip cartridge according to claim 7, wherein:
a timing module is configured to start timing at the starting time point of the first time interval, wherein:
the control module is configured to set the second verification data as the second set of accessible verification data if a timing length of the timing module reaches a time length of the first time interval.

9. The consumable chip cartridge according to claim 8, wherein:
a printing apparatus is configured to supply power to the timing module; or
the consumable chip further includes a power supply module configured to supply power to the timing module.

10. The consumable chip cartridge according to claim 9, wherein:
the control module is also configured to determine whether the first verification data is recognized by the printing apparatus; and
the timing module is also configured to stop timing if the first verification data is recognized by the printing apparatus.

11. A verification method of a consumable chip, wherein the consumable chip stores verification data at least including first verification data and second verification data, the method comprising:
if an access instruction for the verification data is received within the first time interval, outputting the first verification data; and
if the access instruction for the verification data is received within the second time interval, outputting the second verification data.

12. The method according to claim 10, further including:
setting the first verification data as a first set of accessible verification data at a starting time point of the first time interval and setting the second verification data as a second set of accessible verification data at a starting time point of the second time interval, wherein only one set of accessible verification data is available at a same time point.

13. The method according to claim 10, further including:
starting timing at the starting time point of the first time interval, and
setting the second verification data as the second set of accessible verification data if a timing length of the timing module reaches a time length of the first time interval.

14. The method according to claim 10, further including:
determining whether the first verification data is recognized by the printing apparatus; and
stopping timing if the first verification data is recognized by the printing apparatus.

15. A method of using the consumable chip according to claim 1, comprising:
installing the consumable chip in a printing apparatus;
determining whether the consumable chip is recognized by the printing apparatus;
removing the consumable chip from the printing apparatus if the consumable chip is not recognized by the printing apparatus; and
placing the consumable chip for a preset waiting time.

16. A consumable chip, wherein:
the consumable chip stores verification data at least including first verification data and second verification data, wherein the first verification data is different from the second verification data, wherein:
the consumable chip is configured to only output the first verification data when an access instruction for verification data is received before a first preset time; and configured to only output the second verification data when the access instruction for verification data is received after the first preset time, wherein the first preset time is determined by the consumable chip itself.

17. The consumable chip according to claim 16, wherein:
the first preset time is determined by a timing module of the consumable chip.

18. The consumable chip according to claim 16, wherein:
the first preset time is determined by a battery power of a power supply module connected to the consumable chip.
